(19) United States
(12) Patent Application Publication
(10) Pub. No.: US 2007/0249758 A1
(43) Pub. Date: Oct. 25, 2007

(54) Method for Grinding Mineral Materials in the Presence of Binders, Resulting Aqueous Suspensions and Use Thereof

(75) Inventors: Jean-Marc Suau, Lucenay (FR); Denis Ruhlmann, Genay (FR); Christian Jacquemet, Lyon (FR); Jacques Mongoin, Quincieux (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COATEX S.A.S., Genay (FR)

(21) Appl. No.: 11/632,286

(22) PCT Filed: Jul. 5, 2005
(86) PCT No.: PCT/FR05/01715

§ 371 Date: Feb. 2, 2007

(30) Foreign Application Priority Data
Jul. 13, 2004 (FR) 0407805

(51) Int. Cl. B02C 23/18; C09C 3/04; C09D 1/00

(52) U.S. Cl. 523/334; 423/430; 423/592.1

(57) ABSTRACT

The invention concerns a process of grinding of mineral matter in water, in the presence of binders, the stable suspensions of mineral matter ground in water obtained by the process according to the invention, and the use of the said suspensions in aqueous formulations, in particular lining formulations such as aqueous paints, renderings, inks, coatings, sealants, adhesives, glues, and other aqueous formulations incorporating mineral matter. Finally, the invention concerns the aqueous formulations obtained according to the invention.

The present invention concerns the field of aqueous suspensions of ground mineral matter and its uses in aqueous formulations.

The invention firstly concerns a process for grinding of mineral matter in water, in the presence of binders.

The invention also concerns stable suspensions of mineral matter ground in water and obtained by the process according to the invention.

The invention also concerns the use of the said suspensions in aqueous formulations, particularly lining formulations such as notably aqueous paints, renderings, inks, coatings, sealants, adhesives, glues, and other aqueous formulations incorporating mineral matter.

Finally, the invention concerns the aqueous formulations obtained according to the invention.

For a long time mineral fillers such as calcium carbonate and titanium dioxide have been incorporated in aqueous paint formulations in the form of dry powders. However, a recent development has led the skilled man in the art to use aqueous suspensions of mineral matter in his formulations. Indeed, such suspensions prove to be simpler to use, since they eliminate problems relating to the use of powdery materials, and facilitate filler handling operations by simple pumping of the said suspensions.

However, in order to stabilise these suspensions, and prevent problems of sedimentation or aggregation over time, it is necessary to use stabilisation agents more commonly called dispersing agents. Most of these agents have a carboxylic monomer base, and the state of the technique demonstrates the many efforts made in this field. But this technique has brought to light a new problem for the skilled man in the art.

Indeed, in order to regulate the viscosity of the paint he formulates, he must use rheology modifying agents, such as notably thickening agents. And the interactions between the said thickening agents and the dispersing agents contained in the suspensions of mineral fillers are complex, and can lead to prejudicial effects in terms of the rheology of the end product. Thus, the document “Rheology of associative thickener pigment and pigmented commercial latex dispersions” (Progress in Organic Coatings, 17, (1989), pp. 155-173) examines, among other things, the case of an aqueous suspension of titanium dioxide, dispersed by polymethacrylic acid and put in the presence of different thickening agents. It then appears that for a growing concentration of dispersing agent, the use of certain thickening agents of the HEUR (Hydrophobic Ethoxylated Urethane) type leads to a destabilisation of the titanium dioxide, whereas the stability of the suspension is maintained in the presence of cellulosic thickening agents. These phenomena are not systematic, but the state of the technique underlines the particular attention which the skilled man in the art must pay to the choice of the rheology modifiers used. This situation is summarised by the document “Adsorption studies of associative interactions between thickener and pigment particles” (Progress in Organic Coatings, 30, (1997), pp. 161-171): the skilled man the art is strongly encouraged to select attentively new combinations of dispersing agents and thickening agents to exploit their potential (pp 167 introduction), in terms of the stability of the paint thus manufactured.

In addition, continuing to use mineral fillers in the form of aqueous suspensions stabilised by means of dispersing agents, the skilled man in the art has sought to develop intermediate products which consist of simple blends of different constituents of paint, the formulation of the said paint then amounting to the assembly of the different constituents, by simple blending.

Thus, document U.S. Pat. No. 4,025,483 describes a process of stabilisation of an aqueous suspension of pigments of titanium dioxide, starting by blending the latter with plastic polymer particles. The latter have a base of ethylenically unsaturated monomers, a size of 1,000 to 10,000 Å, and a vitreous transition temperature greater than or equal to 30° C. It is then indicated that the resulting composite particles, in aqueous suspension, can be blended with binders with a view to formulating paints (c 1 11 62-66): before formulation of the paint, there is therefore manufacture of an intermediate product containing titanium dioxide-based composites and plastic polymer particles, a binder for paint, and water. However, such a process has the disadvantage that it involves an additional stage which is the manufacture of composite particles (often referred to in the literature through the expression “plastic pigments”). Moreover, this is a process of simple blending, obtained by a small mechanical energy contribution, not leading to a size reduction of the mineral fillers, as in a grinding process. Secondly, referring to the examples, the skilled man in the art understands that it is essential to use a dispersing agent to stabilise the initial suspension of mineral matter.

Document WO 93/12183, for its part, describes a process to prepare an aqueous dispersion of composite particles comprising a latex prepared according to a technique of polymerisation in emulsion and an inorganic material; the dispersion thus obtained may be used in the formulation of aqueous paints. The latex particles used have an average size of between 20 and 5,000 nm, and a vitreous transition temperature higher than 20° C. The latex acts as a binder relative to the inorganic particles, thus conferring improved properties of opacity and brightness on the dry paint film. The mineral filler may notably be titanium dioxide. In a more precise manner, the process consists in preparing two aqueous suspensions (one containing the mineral filler, the other containing the latex), and then in blending them. However, it must be stressed that the process is characterised in that the initial suspension of inorganic matter is necessarily pre-dispersed using a polymer or a copolymer of methacrylic acid, or using one of its salts. Finally, as previously, it is noted that this process consists only of a blending operation and not of an operation to grind the mineral matter used.

Finally, document WO 93/11183 describes a process of preparation of a stable aqueous dispersion, by producing an aqueous suspension of inorganic material and an aqueous suspension of latex, adjusting the values of the Zeta potentials of the two suspensions according to predefined intervals, and then in blending the two suspensions. The stable dispersion obtained may then be used in the manufacture of aqueous paints. The latex particles have an average size of between 20 and 5,000 nm. The mineral filler used may be titanium dioxide, or calcium carbonate. In addition, the solid fraction of the final dispersion containing the filler and the latex particles is higher than 10% by weight. It here appears that the stability is provided via the rigorous control of the Zeta potential of the two initial suspensions, which requires on the one hand the use of a measuring device, and on the other the use of an agent modifying the surface potential of the mineral filler and/or an agent enabling the regulation, for example, of the pH of the aqueous suspension of polymeric binder.

Thus, pursuing his research with a view to producing stable suspensions of mineral matter in the presence of binders, whilst eliminating the use of dispersing agents which can lead to prejudicial effects in terms of the rheology of the end product (by interaction with the thickening agents), the Applicant has found in a surprising manner a new process of manufacture of an aqueous suspension of mineral fillers, characterised in that the said mineral fillers are ground in water in the presence of binders. The product thus obtained has a stability completely compatible with its use in the formulation of aqueous paints.

At this stage, the Applicant wishes to stress that the present invention is distinguished from the previously cited prior art by the fact that the said prior art neither reveals nor teaches the grinding process leading to the diminution of the size of the mineral particles.

In this way, the skilled man in the art who now knows that the suspension of mineral matter which he uses is free of all dispersing agents may use the thickening agents of his choice, without encountering the former problems relating to the interactions with the dispersing agents. In addition, the suspension thus manufactured responds to the wish of the skilled man in the art in the sense that it gives him a product which already contains a part of the binder used in paint. Secondly, and in a completely surprising manner, the binders are not degraded in the course of the grinding process, and fulfil, precisely at this stage of the manufacture, the function of grinding aid agents, going so far as a total elimination of grinding aid agents: the Applicant has, indeed, observed a notable reduction of the size of the particles of mineral matter. And it is well known that the possibility of choosing the size of the mineral particles, in the context of the formulation of a paint, is of great importance for the skilled man in the art. Indeed, the distribution of the size of the particles greatly influences the mechanical and optical properties of the end film, as taught in “Particle-size distribution of fillers and their importance in the preparation of paints” (Deutsche Farben-Zeitschrift, 20 (12), 1966, pp. 565-567). In addition, the process according to the invention allows the use of a very large range of commercially available binders for paints.

The process according to the invention also enables aqueous suspensions of mineral matter to be obtained which, when used in paint formulations, enable paint formulations to be produced having rheological properties which are improved relative to those of the prior art, notably by having increased ICI™ and Stormer™ viscosities.

These improved rheological properties consequently have the advantage of leading to an improved quality of application of the paint.

Finally, the properties of the binder as such are preserved, since the optical properties of the paint film produced according to the invention are not degraded, and nor are the pigmentary compatibility properties of the paints thus formulated.

The invention therefore enables aqueous paint formulations which are stable over time to be obtained, without using dispersing agents. In addition, the invention enables an intermediate product to be obtained in the form of an aqueous suspension of mineral matter and binders, where the latter also play the role of grinding aid agents. In this regard, in the course of this process, it is possible to continue to use “traditional” grinding aid agents. Finally, the aqueous suspension thus obtained by grinding of mineral matter in water and in the presence of binders has a stability which is perfectly compatible with its use in the formulation of aqueous paints. As such, the Applicant wishes to stipulate that the process according to the invention differs from that described in patent application WO 95/31507. The latter document describes the manufacture of a pigment concentrate. The said concentrate is obtained by grinding a colorant mineral matter in the presence of an aqueous binder, and intended to be used as a colorant base. After this operation the size of the pigments is less than 15 μm, and their concentration is between 35 and 65% by weight. And it proves that the descriptive part of the said document instances the use of a dispersing agent, in a proportion of between 4 and 10% by weight. Unlike the present invention, it is therefore essential to use a large quantity of dispersing agent in order to give the aqueous suspension containing the pigment and the binder a satisfactory stability.

The object of the invention is therefore a process for grinding of mineral matter in water, in the presence of binders.

Another object of the invention lies in the stable suspensions of mineral matter ground in water and obtained according to the said process.

Another object of the invention is the use of the said suspensions in aqueous formulations, particularly lining formulations such as notably aqueous paints, renderings, inks, coatings, sealants, adhesives, glues, and other aqueous formulations incorporating mineral matter.

A final object of the invention lies in the aqueous paints obtained according to the invention.

The process according to the invention therefore enables aqueous suspensions of mineral matter to be obtained, without using dispersing agents, and having a rheology compatible with their use in the formulation of aqueous paints.

In addition, the process according to the invention also enables aqueous suspensions of mineral matter to be obtained which, when used in paint formulations, enable paint formulations to be produced having rheological properties which are improved relative to those of the prior art, notably by having increased ICI™ and Stormer™ viscosities.

This process also enables products to be manufactured in accordance with the requirements of the skilled man in the art: they contain water, one or more mineral fillers, and at least one binder.

It also enables the fineness of the mineral matter used to be adjusted by grinding it in the presence of binders: the latter, in this respect, fulfil the function of grinding aid agents.

In addition, the binders are not degraded in the course of the grinding process, and the optical properties of the paint film are not impaired, and nor are the pigmentary compatibility properties of the paints thus formulated.

Finally, the aqueous suspensions of mineral matter ground in this manner and stable over time are used in the formulation of aqueous paints having a very satisfactory stability, and improved rheological properties with a view to their application.

These aims are attained through a new process of manufacture of a stable suspension of mineral matter in water, characterised in that the said mineral matter is ground in the presence of binders.

The Applicant wishes to stipulate that the operation to grind the mineral substance to be refined consists in grinding the mineral substance with a grinding body into very fine particles in an aqueous medium containing the binders.

Thus, the binders and the grinding body, of granulometry advantageously of between 0.20 and 4 millimetres, are added to the aqueous suspension of the mineral substance for grinding. The grinding body generally has the form of particles of materials as diverse as silicon dioxide, aluminium oxide, zirconium oxide or blends thereof, together with synthetic resins of great hardness, steels or other. An example of the composition of such grinding bodies is given by patent FR 2 203 681 which describes the grinding elements formed 30% to 70% by weight of zirconium oxide, 0.1% to 5% of aluminium oxide, and 5 to 20% of silicon dioxide.

The grinding body is preferably added to the suspension in a quantity such that the ratio by weight between this grinding material and the mineral substance for grinding is at least 2/1, this ratio being preferably between the limits 3/1 and 5/1.

The blend of the suspension and the grinding body is then subjected to a mechanical stirring action, as occurs in a traditional grinder with micro-elements.

The time required to attain the desired refinement of the mineral substance after grinding will be defined according to the nature and quantity of the mineral substances to be ground, and according to the stirring method used and the temperature of the medium during the grinding operation.

Another variant of the process is characterised in that the said process possibly uses at least one grinding aid agent. The said agent will be chosen from among all the well-known grinding aid agents, and their blends.

The process according to the invention is also characterised in that the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

Preferentially, the mineral matter is synthetic or natural calcium carbonate, titanium dioxide, or their blends.

More preferentially, the mineral matter is a synthetic calcium carbonate or a natural calcium carbonate chosen from among marble, calcite, chalk or their blends.

The process according to the invention is also characterised in that the binders are chosen from among the binders commonly used in aqueous formulations by the skilled man in the art, and are notably chosen from among the binders of the vinyl ethylene, vinyl versatate, styrene acrylic, styrene butadiene or again acrylic type.

Preferentially, the binders are chosen from among the binders of the vinylversatate and acrylic type.

The process according to the invention is also characterised in that at least 15% by dry weight of mineral matter relative to the total weight of the aqueous suspension, 10% to 50% by dry weight of binders relative to the total weight of the aqueous suspension, and 0 to 5% by dry weight of grinding aid agent relative to the total weight of the aqueous suspension are used.

Preferentially, the said process is characterised in that at least 50% by dry weight of mineral matter relative to the total weight of the aqueous suspension, 10% to 50% by dry weight of binders relative to the total weight of the aqueous suspension, and 0 to 2% by dry weight of grinding aid agent relative to the total weight of the aqueous suspension are used.

Very preferentially, the said process is characterised in that at least 50% by dry weight of mineral matter relative to the total weight of the aqueous suspension, 10% to 25% by dry weight of binders relative to the total weight of the aqueous suspension, and no grinding aid agent, are used.

Another object of the invention lies in the aqueous suspensions of mineral matter ground in the presence of binders obtained by the process according to the invention, and characterised in that they contain at least 15% by dry weight of mineral matter relative to the total weight of the aqueous suspension, 100% to 50% by dry weight of binders relative to the total weight of the aqueous suspension, and 0 to 5% by dry weight of grinding aid agents relative to the total weight of the aqueous suspension.

Preferentially, the said suspensions of mineral matter are characterised in that they contain at least 50% by dry weight of mineral matter relative to the total weight of the aqueous suspension, 10% to 50% by dry weight of binders relative to the total weight of the aqueous suspension, and 0 to 2% by dry weight of grinding aid agent relative to the total weight of the aqueous suspension.

Even more preferentially, the said suspensions of mineral matter are characterised in that they contain at least 50% by dry weight of mineral matter relative to the total weight of the aqueous suspension, 10% to 25% by dry weight of binders relative to the total weight of the aqueous suspension, and no grinding aid agents.

The aqueous suspensions of mineral matter obtained by the process according to the invention are also characterised in that they have a granulometry such that at least 50% of the particles of mineral matter have a diameter less than or equal to 30 μm, i.e. a median diameter d₅₀ less than or equal to 30 μm.

Throughout the present application, the granulometry of the suspensions is determined using a Mastersizer™ 2000 granulometer sold by the company MALVERN™.

Preferentially, the aqueous suspensions of mineral matter obtained by the process according to the invention are also characterised in that they have a granulometry such that at least 50% of the particles of mineral matter have a diameter of less than or equal to 15 μm.

Even more preferentially, the aqueous suspensions of mineral matter obtained by the process according to the invention are also characterised in that they have a granulometry such that at least 50% of the particles of mineral matter have a diameter of less than or equal to 10 μm.

Finally, extremely preferentially, the aqueous suspensions of mineral matter obtained by the process according to the invention are also characterised in that they have a granulometry such that at least 50% of the particles of mineral matter have a diameter of less than or equal to 5 μm.

The said aqueous suspensions are also characterised in that the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

Preferentially, the mineral matter is synthetic or natural calcium carbonate, titanium dioxide, or their blends.

More preferentially, the mineral matter is a synthetic calcium carbonate or a natural calcium carbonate chosen from among marble, calcite, chalk or their blends.

The aqueous suspensions according to the invention are also characterised in that the binders are chosen from among the binders commonly used in aqueous formulations by the skilled man in the art, and are notably chosen from among the binders of the vinyl ethylene, vinyl versatate, styrene acrylic, styrene butadiene or again acrylic type.

Preferentially, the said suspensions are characterised in that the binders are chosen from among the binders of the vinylversatate and acrylic type.

Another object of the invention is the use of the said suspensions in aqueous formulations, particularly lining formulations such as notably aqueous paints, renderings, inks, coatings, sealants, adhesives, glues, and other aqueous formulations incorporating mineral matter.

A final object of the invention lies in the aqueous formulations obtained according to the invention.

Thus, the aqueous paints, renderings, inks, coatings, sealants, adhesives, aqueous formulations incorporating mineral matter and glues according to the invention are characterised in that they contain the mineral aqueous suspensions according to the invention ground in the presence of binders.

The following examples illustrate the invention without however limiting its scope.

### EXAMPLE 1

This example concerns the manufacture of aqueous suspensions of mineral matter through a process of grinding, in the presence of binders, according to the invention (and possibly in the presence of a grinding aid agent: case of test no 8). It also concerns the suspensions of mineral matter thus obtained, from the grinding process according to the invention.

In tests no 1 to no 8, a calcium carbonate is used which is a marble from Avenza (Italy), and which has an initial median diameter noted d₅₀ equal to 10 cam (50% of the calcium carbonate particles have a diameter less than or equal to 10 μm). It is sold by the company OMYA™ under the name Omyacarb™ 10 AV.
A grinder of the Dyno-Mill™ type with a fixed cylinder and rotating pulser is used, the grinding body of which is constituted by zirconium-based balls of diameter in the range 0.6 millimetre to 1 millimetre.
The total volume occupied by the grinding body is 1000 cubic centimetres, while its mass is 2,700 g.
The grinding chamber has a volume of 1400 cubic centimetres.
The circumferential speed of the grinder is 10 metres per second.
The pigment suspension is recycled at a rate of 40 litres per hour.
The outlet of the Dyno-Mill™ grinder is fitted with a 200 micron mesh separator enabling the suspension resulting from the grinding and the grinding body to be separated.
The temperature during each grinding test is maintained at approximately 30° C.

One commences by blending in the water the dry calcium carbonate powder with the binder (and the grinding aid agent in the case of test no 8); the blend is then ground using the previously described device. The grinding time is appropriate for the desired granulometry.

Subsequently, the granulometry of the suspensions is determined as follows.

After grinding, a sample of the pigmentary suspension, the granulometry of which is measured using a Mastersizer™ 2000 granulometer sold by the company MALVERN™, is recovered in a flask. The median diameter d₅₀ of the calcium carbonate particles thus refined is then determined.

The Brookfield™ viscosity of the suspensions is determined as follows.

The Brookfield™ viscosity of the suspension is measured using a Brookfield™ viscometer of type RVT, in the non-stirred flask, at a temperature of 25° C. and at two speeds of rotation of 10 and 100 revolutions per minute with the appropriate moving part. The reading is taken after 1 minute's rotation. 2 Brookfield™ viscosity measurements are obtained, noted respectively μ₁₀ and μ₁₀₀.

After one minute's stirring of the flask which has been at rest for 8 days, the Brookfield™ viscosity of the suspension is measured using the same method.

Test No 1

This test illustrates the invention and uses 11.8% by dry weight relative to the total weight of the suspension of a binder which is a vinylversatate emulsion sold by the company CRAY VALLEY™ under the name Craymul™ 2336 XP. It also uses 52.6% by dry weight relative to the total weight of the suspension of calcium carbonate from Avenza, and the remainder of water.

Test No 2

This test illustrates the invention and uses 11.2% by dry weight relative to the total weight of the suspension, of a binder which is a vinylversatate emulsion sold by the company CRAY VALLEY™ under the name Craymul™ 2336 XP. It also uses 50.0% by dry weight relative to the total weight of the suspension of calcium carbonate from Avenza, and the remainder of water.

Test No 3

This test illustrates the invention and uses 35.0% by dry weight relative to the total weight of the suspension, of a binder which is an acrylic resin sold by the company ROHM & HAAS™ under the name Primal™ HG-74. It also uses 16.7% by dry weight of calcium carbonate from Avenza, relative to the total weight of the suspension, and the remainder of water.

Test No 4

This test illustrates the invention and uses 11.8% by dry weight relative to the total weight of the suspension, of a binder which is an acrylic resin sold by the company BASF™ under the name Acronal™ 290 D. It also uses 52.6% by dry weight of calcium carbonate from Avenza, relative to the total weight of the suspension, and the remainder of water.

Test No 5

This test illustrates the invention and uses 22.7% by dry weight relative to the total weight of the suspension, of a binder which is an acrylic resin sold by the company BASF™ under the name Acronal™ 290 D. It also uses 41.0% by dry weight of calcium carbonate from Avenza, relative to the total weight of the suspension, and the remainder of water.

Test No 6

This test illustrates the invention and uses 12.6% by dry weight relative to the total weight of the suspension, of a binder which is an emulsion with a vinyl acetate ethylene base sold by the company CELANESE™ under the name Mowilith™ LDM 1871. It also uses 52.6% by dry weight of calcium carbonate from Avenza, relative to the total weight of the suspension, and the remainder of water.

Test No 7

This test illustrates the invention and uses 23.9% by dry weight relative to the total weight of the suspension, of a binder which is an emulsion with a vinyl acetate ethylene base sold by the company CELANESE™ under the name Mowilith™ LDM 1871. It also uses 40.7% by dry weight of calcium carbonate from Avenza, relative to the total weight of the suspension, and the remainder of water.

Test No 8

This test illustrates the invention and uses 16.1% by dry weight relative to the total weight of the suspension, of a binder which is an acrylic resin sold by the company BASF™ under the name Acronal™ 290 D. It also uses 60.5% by dry weight of calcium carbonate from Avenza, relative to the total weight of the suspension. It also uses 0.3% by dry weight relative to the total weight of the suspension, of a grinding aid agent which is sodium polyacrylate, and the remainder of water.

The characteristics of the obtained suspensions are shown in table 1.

TABLE 1
characteristics of the aqueous suspensions of ground calcium carbonate
according to tests n° 1 to n° 8

| Test n° | | 1 | 2 | 3 | 4 | 5 | 6 | 7 | 8 |
|---|---|---|---|---|---|---|---|---|---|
| CaCO3 (% by dry weight) | | 52.6 | 50 | 16.7 | 52.6 | 41 | 52.6 | 40.7 | 60.5 |
| Grinding aid agent | | 0 | 0 | 0 | 0 | 0 | 0 | 0 | 0.3 |
| (% by dry weight) | | | | | | | | | |
| Binder (% by dry weight) | | 11.8 | 11.2 | 35.0 | 11.8 | 22.7 | 12.6 | 23.9 | 16.1 |
| d₅₀ (μm) | | 5.3 | 5.3 | 2 | 4.8 | 2.2 | 4.7 | 2.1 | 5.0 |
| Viscosity at | μ₁₀ (mPa · s) | 8700 | 6600 | 640 | 150 | 4840 | 1580 | 10000 | 2260 |
| T = 0 | μ₁₀₀ (mPa · s) | 1690 | 1020 | 300 | 130 | 1270 | 550 | 1600 | 910 |
| Viscosity at | μ₁₀ (mPa · s) | 8040 | 5260 | 360 | 90 | 2650 | 240 | 3280 | 1990 |
| T = 8 | μ₁₀₀ (mPa · s) | 1440 | 870 | 220 | 86 | 860 | 150 | 900 | 760 |
| days | | | | | | | | | |

The percentages by dry weight are understood as relative to the total weight of the suspension.

d₅₀ designates the median diameter of the calcium carbonate particles after grinding (50% of the particles have a diameter of less than this value).

T=0 designates the initial time at which the Brookfield™ viscosities at 10 and 100 revolutions per minute are measured, noted respectively μ₁₀ and μ₁₀₀.

T=8 days designates the time t=8 days, at which the Brookfield™ viscosities at 10 and 100 revolutions per minute are measured after stirring, noted respectively μ₁₀ and μ₁₀₀.

The median diameters corresponding to the tests no 1 to no 8 demonstrate that, for the process according to the invention, the binders used do indeed act as grinding aid agents, in the sense that a notable diminution of the size of the calcium carbonate particles is observed.

Finally, it is observed that each suspension obtained according to the invention is stable over time.

### EXAMPLE 2

This example concerns the manufacture of aqueous paints according to the invention, from aqueous suspensions of calcium carbonate ground in the presence of binders according to the invention, or from dry powders of calcium carbonate according to the prior art.

The paints are formulated by blending the different constituents, using processes well known to the skilled man in the art. The Applicant indicates that, in the following tests, they have indicated only the nature of the carbonates and binders used. Paints contain, of course, a large number of other additives. The complete list of the constituents of each paint, together with their proportions, are shown in the summary tables.

For each formulated paint, its ICI™, Stormer™ and Brookfield™ viscosities are determined using the following methods.

The ICI™ viscosity is determined in a cone-plane viscometer, known as an ICI™ viscometer, notably sold by the company ERICHSEN™, using the method well known to the skilled man in the art. The measurement is made at 25° C. and is noted μ¹(P).

The Stormer™ viscosity is determined in a Stormer viscometer of type KU-1 sold by the company Brookfield™, fitted with a single measuring system. The measurement is made at 25° C. and is noted μ^{S} (K.U).

The Brookfield™ viscosity of the paints is determined at 25° C. in the same manner as that indicated for example 1 in the case of the suspensions of mineral matter. It is noted μ^{B}₁₀ (mPa·s) and μ^{B}₁₀₀ (mPa·s), depending on whether it is determined respectively at 10 or 100 revolutions per minute.

Test No 9

This test concerns the formulation of a matt paint, according to the prior art, into which the carbonate is introduced solely in the form of a dry powder.

This is a blend of 2 calcium carbonates which is marble from Avenza (Italy), one having a median diameter of 5 μm and the other a median diameter of 2 μm. They are sold by the company OMYA™ under the respective names Omyacarb™ 5 AV and Omyacarb™ 2 AV.

The binder used is an acrylic resin sold by the company BASF™ under the name Acronal™ 290 D.

Test No 10

This test concerns the formulation of a matt paint, according to the invention. A part of the calcium carbonate is introduced in the form of a dry powder: this is a calcium carbonate which is marble from Avenza (Italy), with a median diameter of 2 μm. It is sold by the company OMYA™ under the name Omyacarb™ 2-AV.

The other part is introduced in the form of an aqueous suspension according to the invention described in test no 4.

Test No 11

This test concerns the formulation of a matt paint, according to the invention. A part of the calcium carbonate is introduced in the form of a dry powder. This is a blend of 2 calcium carbonates which is marble from Avenza, one having a median diameter of 5 μm and the other a median diameter of 2 μm. They are sold by the company OMYA™ under the names Omyacarb™ 5 AV and Omyacarb™ 2 AV.

The other part is introduced in the form of an aqueous suspension according to the invention and described in test no 5.

The list of the constituents and their proportions by weight are indicated in table 2, for the paints corresponding to tests no 9 to no 11.

For the paints corresponding to these 3 tests, the formulator worked with a constant mass of each constituent: as such, the mass of calcium carbonate is identical for these tests, and equal to 500 g; that of the binder is identical and equal to 160 g.

TABLE 2
composition of paints formulated according to tests n° 9 to n° 11

| | Test n° 9 | Test n° 10 | Test n° 11 |
|---|---|---|---|
| Constituents | (Prior Art) | (Invention) | (Invention) |
| Suspension of | 0 | 570.0 | 0 |
| carbonate ground | | | |
| according to | | | |
| test n° 4 | | | |
| Suspension of | 0 | 0 | 351.7 |
| carbonate ground | | | |
| according to | | | |
| test n° 5 | | | |
| Omyacarb ™ | 300.0 | 0 | 300.0 |
| 5 AV | | | |
| Omyacarb ™ | 200.0 | 200.0 | 55.9 |
| 2 AV | | | |
| Tiona ™ | 80.0 | 80.0 | 80.0 |
| RL 68 | | | |
| Water (added in | 209.3 | 74.3 | 161.7 |
| addition) | | | |
| Acronal ™ | 160.0 | 25.0 | 0 |
| 290 D | | | |
| Coatex ™ | 4.0 | 4.0 | 4.0 |
| P90 | | | |
| Mergal ™ | 2.0 | 2.0 | 2.0 |
| K6N | | | |
| Nopco ™ | 2.0 | 2.0 | 2.0 |
| NDW | | | |
| Butyldiglycol | 10.0 | 10.0 | 10.0 |
| White Spirit | 10.0 | 10.0 | 10.0 |
| Ammonia | 2.7 | 2.7 | 2.7 |
| Coatex Rheo 2000 ™ | 20.0 | 20.0 | 20.0 |
| Total | 1000.0 | 1000.0 | 1000.0 |

The figures designate masses in grams.
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Coatex ™ Rheo 2000 ™ is an associative thickening agent sold by the company COATEX ™

The values of the ICI™, Stormer™ and Brookfield™ viscosities, measured at different times, for the paints formulated in tests no 9 to no 11, are summarised in table 2 b.

TABLE 2 B
viscosities measured in relation to paints formulated according to
tests n° 9 to n°11

| | | Test n° 9 | Test n° 10 | Test n° 11 |
|---|---|---|---|---|
| Viscosities | | (Prior Art) | (Invention) | (Invention) |
| T = 0 | μ^{I} (P) | 2.2 | 2.4 | 2.6 |
| | μ^{S} (K · U) | 87 | 90 | 90 |
| | μ^{B}10 (mPa · s) | 4400 | 4800 | 4900 |
| | μ^{B}100 (mPa · s) | 1590 | 1690 | 1710 |
| T = 24 hours | μ^{I} (P) | 2.3 | 2.6 | 2.6 |
| | μ^{S} (K · U) | 89 | 95 | 98 |
| | μ^{B}10 (mPa · s) | 4500 | 5000 | 5700 |
| | μ^{B}100 (mPa · s) | 1630 | 1940 | 2180 |
| T = 7 days | μ^{B}10 (mPa · s) | 4600 | 5400 | 6100 |
| | μ^{B}100 (mPa · s) | 1670 | 1810 | 2010 |
| T = 1 month | μ^{B}10 (mPa · s) | 4100 | 5300 | 5800 |
| | μ^{B}100 (mPa · s) | 1530 | 1810 | 1880 |

μ^{I} (P): ICI ™ viscosity
μ^{S} (K · U): Stormer ™ viscosity
μ^{B}10 (mPa · s): Brookfield ™ viscosity determined at 10 revolutions per minute
μ^{B}100 (mPa · s): Brookfield ™ viscosity determined at 100 revolutions per minute

The results of table 2 b demonstrate that the paints formulated according to the invention have rheological properties which are improved relative to the prior art: an increase of the ICI™ and Stormer™ viscosities is observed. This improvement leads to an improved quality of application of the paints.

Moreover, the Brookfield™ viscosities observed for the paints according to the invention demonstrate that these formulations are stable over time.

Moreover, a number of optical properties were determined for the paints formulated according to tests no 9 to no 11.

The wet covering power CP of the paints formulated according to tests no 9 to no 11 was compared visually on contrast cards, immediately after application using a standard manual film-stretcher of thickness 150 μm of the said paints.

Tests no 10 and no 11 according to the invention demonstrate a covering power identical to that obtained for test no 9, taken as a reference.

Chromatic coordinates L and b shown in table 3 belong to the chromatic space (L, a, b, Hunter) and are determined on a dry film of the paint for testing, which was previously applied using a standard manual film-stretcher with a thickness of 150 μm, on a glass plate, and then dried at 23° C. for 24 hours in a climatic enclosure at a humidity rate of 50%.

The value of the contrast ratio CR (%)=Yₙ/Y_{b} is measured on a Spectro-Pen™ spectrocolorimeter sold by the company DR LANGE™. The paint was previously applied using a standard manual film-stretcher with a thickness of 150 μm on a contrast card. The reflectance value Y_{b} on the white part of the substrate and the reflectance value Yₙ on the black part of the substrate are then measured. The value obtained in the chromatic space (X, Y, Z) is an average obtained over three measurements.

The brightness was measured on a Micro-Tri-Gloss™ reflectometer sold by the company BRANDT™ at angles equal to 60° and 85° (BS60 and BS85) according to French standard NF T 30-064. The paint was previously applied using a standard manual film-stretcher with a thickness of 150 μm on a glass plate.

TABLE 3
optical properties measured on paints formulated according
to tests n° 9 to n° 11

| Optical | Test n° 9 | Test n° 10 | Test n° 11 |
|---|---|---|---|
| properties | (Prior Art) | (Invention) | (Invention) |
| CP | reference | identical | identical |
| | | to reference | to reference |
| M | 97.4 | 97.6 | 97.5 |
| b | 1.1 | 1.3 | 1.2 |
| CR (%) | 97.1 | 97.2 | 97.3 |
| BS 60 | 3.8 | 3.9 | 3.8 |
| BS 85 | 4.0 | 4.1 | 4.0 |

CP: wet covering power estimated visually
L: whiteness measured on a Spectro-Pen ™ spectrocolorimeter sold by the company DR LANGE ™
b: undertone measured on a Spectro-Pen ™ spectrocolorimeter sold by the company DR LANGE ™
CR (%): contrast ratio measured on a Spectro-Pen ™ spectrocolorimeter sold by the company DR LANGE ™
BS 60, BS 85: brightness measurements at 60 and 85° made on a Micro-Tri-Gloss ™ meter reflectometer sold by the company BRANDT ™, according to French standard NF T 30-064

The results of table 3 demonstrate that the optical properties measured for the paints formulated according to the invention are equivalent to those of the prior art.

Finally, for tests no 9 to no 11, the pigmentary compatibility of the paints thus formulated was determined by measuring the parameter Delta E (ΔE).

The value of Delta E (ΔE) of the matt coloured aqueous formation is determined by adding, to the white base, 5% by weight of black pigment, i.e. 50 grams of black pigment (COLANYL™ Black sold by the company CLARIANT™) to 190 grams of white paint.

This test to measure ΔE is the one known to the skilled man in the art under the term “rub out”.

This test consists in applying, without shearing, using an applicator, 150 μm of the coloured matt or satin paint formulation for testing to a contrast card, slowly and without stress, and in waiting for 45 seconds and then in applying shearing by rubbing the still viscous paint film with the finger, for thirty seconds in any place.

After the film has dried the calorimetric difference between the sheared zone (rubbed zone) and the non-sheared zone (zone where the film has not been rubbed) determined using the Spectro-Pen™ spectrophotometer, allows evaluation (value of ΔE) of whether or not the tested paint composition has satisfactory pigmentary compatibility.

The values of ΔE determined for the coloured formulations produced from the paints corresponding to tests no 9 to no 11 are indicated in table 4.

TABLE 4
values of ΔE measured for different coloured formulations produced from
white bases corresponding to tests n° 9 to n° 11

| Coloured formulations produced | n° 9 | n° 10 | n° 11 |
|---|---|---|---|
| from the white base of the test: | (Prior Art) | (Invention) | (Invention) |
| ΔE | 0.5 | 0.5 | 0.4 |

The values of table 4 demonstrate that the pigmentary compatibility of the coloured paints formulated according to the invention remain identical to that corresponding to the test according to the prior art.

Test No 12

This test concerns the formulation of a matt paint, according to the prior art, into which the carbonate is introduced solely in the form of a dry powder.

Here this is a blend of 2 calcium carbonates which is marble from Avenza, one having a median diameter of 5 μm and the other a median diameter of 2 μm. They are sold by the company OMYA™ under the respective names Omyacarb™ 5-AV and Omyacarb™ 2-AV.

The binder used is a vinylversatate emulsion sold by the company CRAY VALLEY™ under the name Craymul™ 2336 XP.

Test No 13

This test concerns the formulation of a matt paint, according to the invention.

A part of the calcium carbonate is introduced in the form of a dry powder: this is a calcium carbonate which is marble from Avenza, with a median diameter of 2 μm. It is sold by the company OMYA™ under the name Omyacarb™ 2-AV.

The other part is introduced in the form of an aqueous suspension according to the invention and described in test no 1.

The list of the constituents and their proportions by weight are indicated in table 5, for the paints corresponding to tests no 12 and no 13.

For the paints corresponding to these 2 tests, the skilled man in the art worked with a constant mass of each constituent: as such, the mass of calcium carbonate is identical for these tests, and equal to 500 g; that of the binder is identical and equal to 160 g.

TABLE 5
composition of paints formulated according to tests n° 12 and n° 13

| | Test n° 12 | Test n° 13 |
|---|---|---|
| Constituents | (Prior Art) | (Invention) |
| Suspension of | 0 | 570 |
| carbonate ground | | |
| according to | | |
| test n° 1 | | |
| Omyacarb ™ | 300 | |
| 5-AV | | |
| Omyacarb ™ | 200 | 200 |
| 2-AV | | |
| Tiona ™ | 80.0 | 80.0 |
| RL 68 | | |
| Water (added in | 207.5 | 73.5 |
| addition) | | |
| Craymul ™ | 160.0 | 25.0 |
| 2336 XP | | |
| Coatex ™ | 4.0 | 4.0 |
| P90 | | |
| Mergal ™ | 2.0 | 2.0 |
| K6N | | |
| Nopco ™ | 1.0 | 1.0 |
| NDW | | |
| Butyldiglycol | 10.0 | 10.0 |
| White Spirit | 10.0 | 10.0 |
| Ammonia | 4.5 | 4.5 |
| Coatex Rheo | 20.0 | 20.0 |
| 2000 ™ | | |
| Total | 1000.0 | 1000.0 |

The figures designate masses in grams.
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Coatex ™ Rheo 2000 ™ is an associative thickening agent sold by the company COATEX ™

The values of the ICI™, Stormer™ and Brookfield™ viscosities, measured at different times, for the paints formulated in tests no 12 and no 13, are summarised in table 5 b.

TABLE 5 b
viscosities measured in relation to paints formulated according
to tests n° 12 and n° 13

| | | Test n° 12 | Test n° 13 |
|---|---|---|---|
| Viscosities | | (Prior Art) | (Invention) |
| T = 0 | μ^{I} (P) | 2.7 | 3.3 |
| | μ^{S} (K · U) | 84 | 100 |
| | μ^{B}10 (mPA · s) | 3000 | 4500 |
| | μ^{B}100 (mPa · s) | 1320 | 2010 |
| T = 24 hours | μ^{I (P)} | 2.7 | 3.2 |
| | μ^{S} (K · U) | 97 | 108 |
| | μ^{B}10 (mPA · s) | 4200 | 5000 |
| | μ^{B}100 (mPa · s) | 2150 | 2750 |
| T = 7 days | μ^{B}10 (mPA · s) | 3400 | 3700 |
| | μ^{B}100 (mPa · s) | 1610 | 1790 |
| T = 1 month | μ^{B}10 (mPA · s) | 3100 | 3400 |
| | μ^{B}100 (mPa · s) | 1410 | 1610 |

μ^{I} (P): ICI ™ viscosity
μ^{S} (K · U): Stormer ™ viscosity
μ^{B}10 (mPa · s): Brookfield ™ viscosity determined at 10 revolutions per minute
μ^{B}100 (mPa · s): Brookfield ™ viscosity determined at 100 revolutions per minute

The results of table 5 b demonstrate that the paint formulated according to the invention has rheological properties which are improved relative to the prior art: an increase of the ICI™ and Stormer™ viscosities is observed. This improvement leads to an improved quality of application of the paints.

Moreover, the Brookfield™ viscosities observed for the paint according to the invention demonstrate that this formulation is stable over time.

Test No 14

This test concerns the formulation of a matt paint, according to the prior art.

A part of the calcium carbonate is introduced in the form of a dry powder: this is a calcium carbonate which is marble from Avenza, with a median diameter of 2 μm. It is sold by the company OMYA™ under the name Omyacarb™ 2-AV.

The other part is introduced in the form of an aqueous suspension of calcium carbonate ground with 0.3% by dry weight of a traditional grinding agent which is a sodium polyacrylate, having a median diameter of 5 μm, and a concentration by dry weight equal to 75% by weight relative to the total weight of the suspension.

Test No 15

This test concerns the formulation of a matt paint, according to the invention.

A part of the calcium carbonate is introduced in the form of a dry powder: this is a calcium carbonate which is marble from Avenza, with a median diameter of 2 μm. It is sold by the company OMYA™ under the name Omyacarb™ 2-AV.

The other part is introduced in the form of an aqueous suspension according to the invention and described in test no 8.

The list of the constituents and their proportions by weight are indicated in table 6, for the paints corresponding to tests no 14 and no 15.

For the paints corresponding to these 2 tests, the skilled man in the art worked with a constant mass of each constituent: as such, the mass of calcium carbonate is identical for these tests, and equal to 500 g; that of the binder is identical and equal to 160 g.

TABLE 6
composition of paints formulated according to tests n° 14 and n° 15

| | Test n° 14 | Test n° 15 |
|---|---|---|
| Constituents | (Prior Art) | (Invention) |
| Suspension of | 0 | 497.4 |
| carbonate ground | | |
| according to | | |
| test n° 8 | | |
| Suspension of | 400.0 | |
| carbonate ground | | |
| according to | | |
| test n° 14 | | |
| Omyacarb ™ | 200.0 | 200.0 |
| 2-AV | | |
| Tiona ™ | 80.0 | 80.0 |
| RL 68 | | |
| Water (added in | 113.3 | 175.9 |
| addition) | | |
| Acronal ™ | 160.0 | 0.0 |
| 290 D | | |
| Mergal ™ | 2.0 | 2.0 |
| K6N | | |
| Nopco ™ | 2.0 | 2.0 |
| NDW | | |
| Butyldiglycol | 10.0 | 10.0 |
| White Spirit | 10.0 | 10.0 |
| Ammonia | 2.7 | 2.7 |
| Coatex Rheo | 20.0 | 20.0 |
| 2000 ™ | | |
| Total | 1000.0 | 1000.0 |

The figures designate masses in grams.
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Coatex ™ Rheo 2000 ™ is an associative thickening agent sold by the company COATEX ™

The values of the ICI™, Stormer™ and Brookfield™ viscosities, measured at different times, for the paints formulated in tests no 14 and no 15, are summarised in table 6 b.

TABLE 6 b
viscosities measured in relation to paints formulated according
to tests n° 14 and n° 15

| | | Test n° 14 | Test n° 15 |
|---|---|---|---|
| Viscosities | | (Prior Art) | (Invention) |
| T = 0 | μ^{I (P)} | 2.2 | 2.6 |
| | μ^{S} (K · U) | 89 | 93 |
| | μ^{B}10 (mPA · s) | 5500 | 6000 |
| | μ^{B}100 (mPa · s) | 1640 | 1890 |
| T = 24 hours | μ^{I (P)} | 2.3 | 2.7 |
| | μ^{S} (K · U) | 91 | 96 |
| | μ^{B}10 (mPA · s) | 5400 | 5900 |
| | μ^{B}100 (mPa · s) | 1800 | 2080 |
| T = 7 days | μ^{B}10 (mPA · s) | 5600 | 6000 |
| | μ^{B}100 (mPa · s) | 1800 | 2020 |
| T = 1 month | μ^{B}10 (mPA · s) | 5500 | 6000 |
| | μ^{B}100 (mPa · s) | 1650 | 2000 |

μ^{I} (P): ICI ™ viscosity
μ^{S} (K · U): Stormer ™ viscosity
μ^{B}10 (mPa · s): Brookfield ™ viscosity determined at 10 revolutions per minute
μ^{B}100 (mPa · s): Brookfield ™ viscosity determined at 100 revolutions per minute

The results of table 6 b demonstrate that the paint formulated according to the invention has rheological properties which are improved relative to the prior art: an increase of the ICI™ and Stormer™ viscosities is observed. This improvement leads to an improved quality of application of the paints.

Moreover, the Brookfield™ viscosities observed for the paint according to the invention demonstrate that this formulation is stable over time.

### EXAMPLE 3

This example concerns the manufacture of aqueous suspensions of mineral matter through a process of grinding, in the presence of binders, according to the invention. It also concerns the suspensions of mineral matter thus obtained, from the grinding process according to the invention.

In test no 16, a precipitated calcium carbonate having an initial median diameter noted d₅₀ equal to 4.8 μm (50% of the calcium carbonate particles have a diameter less than or equal to 4.8 μm) is used. It is sold by the company SOLVAY™ under the name Socal™ P3.

In tests no 17 and 18, a calcium carbonate is used which is a marble from Avenza (Italy), and which has an initial median diameter noted d₅₀ equal to 10 μm (50% of the calcium carbonate particles have a diameter less than or equal to 10 μm). It is sold by the company OMYA™ under the name Omyacarb™ 10 AV.

The mineral matter is ground according to the invention in the presence of a binder (case of tests no 16 and 17) or of a blend of two binders (test no 18) using the same method as that described for example 1.

For tests no 16 to 18, the granulometry of the aqueous suspensions is determined, after grinding, in the same manner as that described for example 1.

Subsequently, using the same method as that used in the course of example 1, the Brookfield™ viscosities at two speeds of rotation of 10 and 100 revolutions per minute, noted respectively μ₁₀ and μ₁₀₀, are determined, at times t=0 and t=8 days after one minute's stirring.

Test No 16

This test illustrates the invention and uses 20.0% by dry weight relative to the dry weight of mineral filler, of a styrene-acrylic binder sold by the company CRAY VALLEY™ under the name Craymul™ 5432. It also uses 58.3% by dry weight relative to the total weight of the suspension of precipitated calcium carbonate Socal™ P3, and the remainder of water.

Test No 17

This test illustrates the invention and uses 20.0% by dry weight relative to the dry weight of mineral filler, of an acrylic binder sold by the company CRAY VALLEY™ under the name Craymul™ 4511. It also uses 58.4% by dry weight relative to the total weight of the suspension of calcium carbonate from Avenza, and the remainder of water.

Test No 18

This test illustrates the invention and uses 20.0% by dry weight relative to the dry weight of mineral filler, of a blend of binders consisting of Acronal™ DL 966 and Acronal™ S 360 D (in a ratio of 1:1 by weight), which are respectively binders of the styrene-butadiene and styrene-acrylic types, both sold by the company BASF™. It also uses 63.1% by dry weight of calcium carbonate from Avenza, relative to the total weight of the suspension, and the remainder of water.

The values of the median diameters d₅₀ determined after grinding, and the values of the Brookfield™ viscosities μ₁₀ and μ₁₀₀, measured after grinding at times t=0 and t=8 days after one minute's stirring, are indicated in table 7.

TABLE 7
median diameter d_{50 after grinding, and Brookfield ™ viscosities μ}₁₀ and μ₁₀₀,
after grinding (at times t = 0 and t = 8 days after one minute's stirring).

| Test n° | | 16 | 17 | 18 |
|---|---|---|---|---|
| Calcium carbonate | | 58.3 | 58.4 | 63.1 |
| (% by dry weight | | | | |
| relative to the | | | | |
| total weight of | | | | |
| the suspension) | | | | |
| Binder (% by dry | | 20% | 20% | 20% |
| weight relative | | | | |
| to the dry weight | | | | |
| of filler) | | | | |
| d₅₀ (μm) | | 2.3 | 6.0 | 5.0 |
| Viscosity at | μ₁₀ (mPa · s) | 5540 | 790 | 640 |
| T = 0 | μ₁₀₀ (mPa · s) | 800 | 410 | 200 |
| Viscosity at | μ₁₀ (mPa · s) | 2410 | 850 | 90 |
| | μ₁₀₀ (mPa · s) | 560 | 290 | 90 |

The median diameters corresponding to the tests no 16 to no 18 demonstrate that, for the process according to the invention, the binders used do indeed act as grinding aid agents, in the sense that a notable diminution of the size of the calcium carbonate particles is observed.

Finally, it is observed that each suspension obtained according to the invention is stable over time.

### EXAMPLE 4

This example illustrates the invention and concerns the manufacture of a rendering, a coating and a glue according to the invention.

Test No 19

This test illustrates the invention and concerns the manufacture of a rendering according to the invention.

To accomplish this, a rendering is therefore produced, using the methods well known to the skilled man in the art, the composition of which is given in table 8.

This test notably uses the aqueous suspension of mineral matter ground according to the invention, and obtained in the course of test no 16.

TABLE 8
composition of a rendering formulation according to the invention

| Constituents | Weight (g) |
|---|---|
| Aqueous suspension | 339.6 |
| of mineral matter | |
| according to test | |
| n° 16 | |
| Water | 18.9 |
| Coatex ™ | 3.0 |
| P90 | |
| Mergal ™ | 2.0 |
| K6N | |
| TiO2 RL68 | 60.0 |
| Durcal ™ | 110.0 |
| 130 | |
| Craymul ™ | 134.0 |
| 5432 | |
| Mono-ethylene | 10.0 |
| glycol | |
| White Spirit | 10.0 |
| Granicalcium ™ | 300.0 |
| Ammonia | 2.5 |
| Viscoatex ™ | 20.0 |
| 46 | |

Coatex ™ P90 is an acrylic dispersing agent sold by the company COATEX ™
Mergal ™ K6N is a biocide sold by the company TROY ™
TiO2 RL 68 is titanium dioxide sold by the company MILLENIUM ™
Durcal ™ 130 is a calcium carbonate sold by the company OMYA ™
Craymul ™ 5432 is a styrene-acrylic binder sold by the company CRAY VALLEY ™
Viscoatex ™ 46 is an acrylic thickener sold by the company COATEX ™

By this means a formulation is obtained the Brookfield™ viscosities of which, measured at 1, 10 and 100 revolutions per minute (using the previously described methods), are respectively equal, at time t=0, to:

980,000 mPa·s, 120,000 mPa·s, 18,500 mPa·s.

These viscosities, measured at a time t=24 hours, are respectively equal to:

810,000 mPa·s, 115,000 mPa·s, 17,200 mPa·s.

These values demonstrate that the Brookfield™ viscosities obtained are perfectly compatible with a use of the formulation according to the invention in the field of renderings.

Test No 20

This test illustrates the invention and concerns the manufacture of a coating according to the invention.

To accomplish this, a coating is therefore produced, using the methods well known to the skilled man in the art, the composition of which is given in table 9.

This test notably uses the aqueous suspension of mineral matter ground according to the invention, and obtained in the course of test no 16.

TABLE 9
composition of a coating formulation according to the invention

| Constituents | Weight (g) |
|---|---|
| Aqueous suspension | 82.2 |
| of mineral matter | |
| according to test | |
| n° 16 | |
| Water | 358.0 |
| Coatex ™ P90 | 3.0 |
| Nopco ™ NDW | 2.0 |
| Mergal ™ K6N | 0.6 |
| Socal ™ P3 | 364.0 |
| Myanit ™ | 120.0 |
| Soda | 24.0 |
| Viscoatex ™ 46 | 76.2 |

Coatex ™ P90 is an acrylic dispersing agent sold by the company COATEX ™
Nopco NDW is an anti-foaming agent sold by the company COGNIS ™
Mergal ™ K6N is a biocide sold by the company TROY ™
Myanit ™ is a calcium carbonate sold by the company OMYA ™
Viscoatex ™ 46 is an acrylic thickener sold by the company COATEX ™

By this means a formulation is obtained the Brookfield™ viscosities of which, measured at 1, 10 and 100 revolutions per minute (using the previously described methods but in this case with a module of the Helipath™ type), are respectively equal, at time t=0, to:

590,000 mPa·s, 88,000 mPa·s, 31,000 mPa·s.

These viscosities, measured at a time t=24 hours, are respectively equal to:

410,000 mPa·s, 66,000 mPa·s, 25,500 mPa·s.

These values demonstrate that the Brookfield™ viscosities obtained are perfectly compatible with a use of the formulation according to the invention in the field of coatings.

Test No 21

This test illustrates the invention and concerns the manufacture of a glue according to the invention.

To accomplish this, a glue is therefore produced, using the methods well known to the skilled man in the art, the composition of which is given in table 10.

This test notably uses the aqueous suspension of mineral matter ground according to the invention, and obtained in the course of test no 16.

TABLE 10
composition of a glue formulation according to the invention

| Constituents | Weight (g) |
|---|---|
| Aqueous suspension | 205.8 |
| of mineral matter | |
| according to test | |
| n° 16 | |
| Mergal ™ K6N | 2.0 |
| Nopco ™ NDW | 1.0 |
| Craymul ™ 5432 | 120.0 |
| Durcal ™ 2 | 140.0 |
| Durcal ™ 130 | 524.4 |
| Butyldiglycol | 14.0 |
| Water | 32.2 |
| Ammonia | 10.0 |
| Viscoatex ™ 46 | 71.6 |

Mergal ™ K6N is a biocide sold by the company TROY ™
Nopco ™ NDW is an anti-foaming agent sold by the company COGNIS ™
Craymul ™ 5432 is a styrene-acrylic binder sold by the company CRAY VALLEY ™
Durcal ™ 2 and Durcal ™ 130 are calcium carbonates sold by the company OMYA ™
Viscoatex ™ 46 is an acrylic thickener sold by the company COATEX ™

By this means a formulation is obtained the Brookfield™ viscosities of which, measured at 1, 10 and 100 revolutions per minute (using the previously described methods but in this case with a module of the Helipath™ type), are respectively equal, at time t=0, to:

450,000 mPa·s, 270,000 mPa·s, 51,000 mPa·s.

These viscosities, measured at a time t=24 hours, are respectively equal to:

1,100,000 mPa·s, 340,000 mPa·s, 85,000 mPa·s.

These values demonstrate that the Brookfield™ viscosities obtained are perfectly compatible with a use of the formulation according to the invention in the field of glues.

1: A process of manufacture of a stable suspension of mineral matter in water, wherein the mineral matter is ground in the presence of binders.

2: The process according to claim 1, wherein the mineral matter is at least one pigment and/or a mineral filler, selected from the group consisting of natural or synthetic calcium carbonate, the dolomites, kaolin, talc, gypsum, lime, magnesia, titanium dioxide, satin white, aluminium trioxide, aluminium trihydroxide, mica, zinc oxides, iron oxides, barium sulphate and a blend of these fillers.

3: The process according to claim 2 wherein the mineral matter is synthetic or natural calcium carbonate, titanium dioxide, or their blends.

4: The process according to claim 3 wherein the mineral matter is a synthetic calcium carbonate or a natural calcium carbonate selected from the group consisting of marble, calcite, chalk and a blend of marble, calcite or chalk.

5: The process according to claim 1 wherein the binders are selected from the binders consisting of the vinyl ethylene, vinyl versatate, styrene acrylic, styrene butadiene and acrylic types.

6: The process according to claim 5 wherein the binders are selected from the binders consisting of the vinylversatate and acrylic types.

7: The process according to claim 1 wherein, in addition, at least one grinding aid agent is used.

8: The process according to claim 1 wherein at least 15% by dry weight of mineral matter relative to the total weight of the aqueous suspension, 10% to 50% by dry weight of binders relative to the total weight of the aqueous suspension, and 0 to 5% by dry weight of grinding aid agents relative to the total weight of the aqueous suspension are used.

9: The process according to claim 8 wherein at least 50% by dry weight of mineral matter relative to the total weight of the aqueous suspension, 10% to 50% by dry weight of binders relative to the total weight of the aqueous suspension, and 0 to 2% by dry weight of grinding aid agents relative to the total weight of the aqueous suspension are used.

10: The process according to claim 9 wherein at least 50% by dry weight of mineral matter relative to the total weight of the aqueous suspension, 10% to 25% by dry weight of binders relative to the total weight of the aqueous suspension, and no grinding aid agents are used.

11: Aqueous suspensions of mineral matter ground in the presence of binders wherein the aqueous suspensions have a content by dry weight of mineral matter greater than or equal to 15%, and contain 10% to 50% by dry weight of binders relative to the total weight of the aqueous suspension, and 0 to 5% by dry weight of grinding aid agents relative to the total weight of the aqueous suspension

12: The aqueous suspensions of mineral matter ground in the presence of binders according to claim 11, wherein the content by dry weight of mineral matter is greater than or equal to 50%, the dry weight of binders relative to the total weight of the aqueous suspension is 10% to 25%, and the dry weight of grinding aid agents relative to the total weight of the aqueous suspension is 0 to 2%.

13: The aqueous suspensions of mineral matter ground in the presence of binders according to claim 12, wherein the content by dry weight of mineral matter is greater than or equal to 50%, and the dry weight of binders relative to the total weight of the aqueous suspension is 10% to 25%, and no grinding aid agent is present.

14: The aqueous suspensions of mineral matter ground in the presence of binders according to claim 11 wherein the aqueous suspensions have a granulometry such that wherein at least 50% of the particles of mineral matter have a diameter less than or equal to 30 μm.

15: The aqueous suspensions of mineral matter ground in the presence of binders according to claim 14, wherein at least 50% of the particles of mineral matter have a diameter less than or equal to 15 μm.

16: The aqueous suspensions of mineral matter ground in the presence of binders according to claim 15, wherein at least 50% of the particles of mineral matter have a diameter less than or equal to 10 μm.

17: The aqueous suspensions of mineral matter ground in the presence of binders according to claim 16, wherein at least 50% of the particles of mineral matter have a diameter less than or equal to 5 μm.

18: The aqueous suspensions of mineral matter ground in the presence of binders according to claim 11 wherein the mineral matter is at least one pigment and/or a mineral filler, selected from the group consisting of natural or synthetic calcium carbonate, the dolomites, kaolin, talc, gypsum, lime, magnesia, titanium dioxide, satin white, aluminium trioxide, aluminium trihydroxide, mica, zinc oxides iron oxides, barium sulphate and a blend of these fillers.

19: The aqueous suspensions of mineral matter ground in the presence of binders according to claim 18, wherein the mineral matter is synthetic or natural calcium carbonate, titanium dioxide, or their blends.

20: The aqueous suspensions of mineral matter ground in the presence of binders according to claim 19, wherein the mineral matter is a synthetic calcium carbonate or a natural calcium carbonate selected from the group consisting of marble, calcite, chalk and a blend of marble, calcite or chalk.

21: The aqueous suspensions according to claim 11 wherein the binders are selected from group consisting of a vinyl ethylene binder, a vinyl versatate binder, a styrene acrylic binder, a styrene butadiene binder and an acrylic binder.

22: The aqueous suspensions according to claim 21 wherein the binders are at least one selected from the group consisting of a vinylversatate binder and an acrylic binder.

23: A method for the preparation of an aqueous formulation incorporating mineral matter comprising adding to the aqueous formulation incorporating mineral matter aqueous suspensions of mineral matter ground in the presence of binders according to claim 11 wherein the aqueous formulation incorporating mineral matter is a lining formulation.

24: Aqueous paints comprising the aqueous suspensions of mineral matter ground in the presence of binders according to claim 11.

25: Renderings comprising the aqueous suspensions of mineral matter ground in the presence of binders according to claim 11.

26: Inks comprising the aqueous suspensions of mineral matter ground in the presence of binders according to claim 11.

27: Coatings comprising the aqueous suspensions of mineral matter ground in the presence of binders according to claim 11.

28: Sealants comprising the aqueous suspensions of mineral matter ground in the presence of binders according to claim 11.

29: Adhesives comprising the aqueous suspensions of mineral matter ground in the presence of binders according to claim 11.

30: Glues comprising the aqueous suspensions of mineral matter ground in the presence of binders according to claim 11.

31: Aqueous formulations incorporating mineral matter comprising the aqueous suspensions of mineral matter ground in the presence of binders according to claim 11.

32: The process according to claim 2 wherein the blend of fillers is selected from the group consisting of a talc-calcium carbonate blend, a calcium carbonate-kaolin blend, a calcium carbonate-aluminium trihydroxide blend, a calcium carbonate-aluminium trioxide blend, a blend with synthetic or natural fibres, a talc-calcium carbonate costructure, a talc-titanium dioxide costructure, other mineral costructures and a blend thereof.

33: The aqueous suspensions of mineral matter according to claim 18 wherein the blend of fillers is selected from the group consisting of a talc-calcium carbonate blend, a calcium carbonate-kaolin blend, a calcium carbonate-aluminium trihydroxide blend, a calcium carbonate-aluminium trioxide blend, a blend with synthetic or natural fibres, a talc-calcium carbonate costructure, a talc-titanium dioxide costructure, other mineral costructures and a blend thereof.

34: The method of claim 23, wherein the lining formulation is one selected from the group consisting of an aqueous paint, a rendering, an ink, a coating, a sealant, an adhesive and a glue.
